(19) United States
(12) Patent Application Publication
(10) Pub. No.: US 2021/0233169 A1
(43) Pub. Date: Jul. 29, 2021

(54) BLOCK CHAIN-BASED CRYPTOCURRENCY TRADING BROKERAGE SERVER AND TRADING BROKERAGE METHOD CAPABLE OF CONTROLLING PRICE FLUCTUATION AND PREVENTING CHANGE OF OWNERSHIP DUE TO HACKING

(71) Applicant: Chung Jong LEE, Gangwon-do (KR)

(72) Inventors: Chung Jong LEE, Gangwon-do (KR); Seung Jun SONG, Bucheon-si Gangwon-do (KR)

(21) Appl. No.: 17/051,976

(22) PCT Filed: May 7, 2019
(86) PCT No.: PCT/KR2019/005404

§ 371 Date: Oct. 30, 2020

(30) Foreign Application Priority Data
May 8, 2018 (KR) 10-2018-0052567

(51) Int. Cl. G06Q 40/04; G06Q 20/38; G06Q 20/06

(52) U.S. Cl. CPC G06Q 40/04; G06Q 20/065; G06Q 20/382

(57) ABSTRACT

The present invention relates to a cryptocurrency trading brokerage server and a trading brokerage method in which records of trading digital tokens are encrypted and connected to node servers through a network having a block chain structure. A transaction between a first wallet client requesting to sell digital tokens and a second wallet client requesting to purchase digital tokens is matched to within a certain pre-set range of a basic ratio value to control price fluctuation. Also, a request from a fourth wallet client is received and an ownership certification key value matched to a personal key of the fourth wallet client is stored in a database of the trading brokerage server, thereby preventing a change of ownership due to hacking.

### BACKGROUND OF THE DISCLOSURE

### Technical Field

The present disclosure relates to a block chain-based cryptocurrency trading brokerage server and trading brokerage method.

### Background Art

In block chain-based cryptocurrency, a decentralized model in which all or part of trading records are distributed to and stored in a plurality of nodes to issue currency has been introduced in a centralized model in which a central server issues currency, thereby removing factors of currency price fluctuation (or volatility) based on a policy of issuing entity.

However, despite the introduction of the decentralized model, ledgers distributed to block chains record only issuance of currency and transmission details of currency and do not record an exchange transaction between cryptocurrency and other real money, causing an exchange value to be fluctuated according to demand and supply in an exchange site brokering an exchange transaction, and with such an exchange transaction model, cryptocurrency cannot satisfy a currency function as a value storage means due to the rapid fluctuation of the exchange value.

Therefore, the block chain-based cryptocurrency of the related art cannot perform a payment function as a means of exchange for spot goods.

Meanwhile, in order to improve unstable value accumulation of cryptocurrencies, cryptocurrencies based on the gold standard, which was attempted in real money, have also appeared. However, the gold standard cryptocurrency may have a stable market price but market price liquidity of a monetary system is insufficient, and due to the insufficient market price liquidity, the money system lacks growth factors.

In addition, since an exchange transaction between real money and cryptocurrency at the exchange site is not recorded on the block chain, if the record of the exchange site is hacked or lost, the cryptocurrency will be lost. If a private key or public key of a wallet that proves a holding record of cryptocurrency is lost, the owned cryptocurrency is lost and there is a problem in maintaining reliability of the transaction and ownership.

(Patent document 1) Korean Patent Registration No. 10-1628007 (Published on Jun. 13, 2016)

(Patent document 2) Korean Patent Registration No 10-1628009 [symbol] (Published on Jun. 13, 2016)

### SUMMARY

### Technical Problem

An aspect of the present disclosure provides a block chain-based cryptocurrency brokerage server and a trading brokerage method capable of mitigating price fluctuation of cryptocurrency as a trading target, and maintaining reliability and stability by authenticating ownership and trading of cryptocurrency.

### Technical Solution

The present disclosure provides a cryptocurrency trading brokerage server in which a trading record of digital tokens is encrypted and which is connected to node servers by a network having a block chain structure, wherein the trading brokerage server stores a trading rate value of assets conversion value for the digital token in a database of the trading brokerage server, the trading rate value includes a basic trading rate value and a current trading rate value, and the trading brokerage server matches a trading between a first wallet client requesting sale of digital tokens and a second wallet client requesting purchase of digital tokens within a predetermined fixed range of the basic rate value.

Also, the present disclosure provides a cryptocurrency trading brokerage server in which a trading record of digital tokens is encrypted and which is connected to node servers by a network having a block chain structure, wherein the trading brokerage server stores an ownership authentication key value matched to a private key of a fourth wallet client upon receiving a request from the fourth wallet client in a database of the trading brokerage server.

Further, the present disclosure provides a cryptocurrency trading brokerage method of a cryptocurrency trading brokerage server in which a trading record of digital tokens is encrypted and which is connected to node servers by a network having a block chain structure, including: storing a basic trading rate value of an asset conversion value for a digital token in a database of the trading brokerage server; receiving, by the trading brokerage server, a request for sale of digital tokens from a first wallet client; receiving, by the trading brokerage server, a request for purchase of digital tokens from a second wallet client; and matching, by the trading brokerage server, a trading if a sale request price of the first wallet client and a purchase request price of the second wallet client are equal and are within a predetermined range of a basic rate value.

Furthermore, the present disclosure provides a cryptocurrency trading brokerage method of a cryptocurrency trading brokerage server in which a trading record of digital tokens is encrypted and which is connected to node servers by a network having a block chain structure, including: storing an ownership authentication key value matched to a private key of a fourth wallet client upon receiving a request from the fourth wallet client in a database of the trading brokerage server.

### Advantageous Effects

With the cryptocurrency trading brokerage server in which a trading record of digital tokens is encrypted and which is connected to node servers by a network having a block chain structure and the cryptocurrency trading brokerage method according to the present disclosure, a value of the digital token is secured as actual assets, i.e., assets such as gold, in a monetary system, supporting stability, a rapid market price fluctuation are controlled by limiting a range of a market price of the digital token, the demand causing price rise due to lack of currency in the monetary system is absorbed by issuing digital tokens in case of limited market price rise, and, at the time of issuance, digital tokens are provided to existing digital token holders at a lower price than the issuance price, providing incentives to reward early participants.

As a result, the cryptocurrency according to the present disclosure may serve as real money in a digital world, alleviating imbalances in the monetary system between countries, promoting economic stability of a country where currency may become temporarily unstable, and establishing a genuine cryptocurrency currency environment based on a monetary system supported by assets such as gold.

In addition, since an exchange transaction between the real currency and the cryptocurrency is recorded on the block chain, even if a record of an exchange site is hacked or lost, the owned cryptocurrency may be recovered, and even if a private key or a public key of a wallet verifying a possession record of cryptocurrency is lost, authentication information already recorded in a trading authentication server may be reconfirmed, thereby maintaining reliability of trading and ownership.

In addition, since a blind wallet system is able to verify an owner and guarantees anonymity of the use of cryptocurrency, anonymity may be guaranteed in a currency trading as long as there is no special criminal relation.

### BRIEF DESCRIPTION OF THE DRAWINGS

FIG. 1 shows a cryptocurrency trading brokerage server according to an aspect of the present disclosure.

FIG. 2 shows illustrating a cryptocurrency trading brokerage server according to another aspect of the present disclosure.

FIG. 3 shows a cryptocurrency trading brokerage method according to an aspect of the present disclosure.

FIG. 4 shows a cryptocurrency trading brokerage method according to another aspect of the present disclosure.

FIG. 5 shows another embodiment of a cryptocurrency trading brokerage method according to another aspect of the present disclosure.

FIG. 6 shows another embodiment of a cryptocurrency trading brokerage method according to another aspect of the present disclosure.

### BEST MODE

According to an aspect of the present disclosure, there is provided a cryptocurrency trading brokerage server in which a trading record of digital tokens is encrypted and which is connected to node servers by a network having a block chain structure, wherein the trading brokerage server stores a trading rate value of assets conversion value for the digital tokens in a database of the trading brokerage server, the trading rate value includes a basic trading rate value and a current trading rate value, and the trading brokerage server matches a trading between a first wallet client requesting sale of digital tokens and a second wallet client requesting purchase of digital tokens within a predetermined fixed range of the basic rate value.

### Mode for Acrrying Out the Invention

The terminology used herein is for the purpose of describing particular embodiments only and is not intended to be limiting of the invention. As used herein, the singular forms “a”, “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms used herein including the technical or scientific terms have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. Like reference numerals in the drawings denote like members. In describing the present disclosure, if a detailed description for a related known function or construction is considered to unnecessarily divert the gist of the present disclosure, such explanation has been omitted but would be understood by those skilled in the art. The size of each component in the drawings may be exaggerated for the sake of explanation and does not mean a size that is actually applied.

The embodiments described herein may have an aspect that is entirely hardware or partially hardware and partially software or entirely software. In the present disclosure, “unit”, “module”, “device” or “system” refers to a computer-related entity such as hardware, a combination of hardware and software, or software. For example, in the present disclosure, unit, module, device, or system may be a running process, a processor, an object, an executable file, a thread of execution, a program, and/or a computer but is not limited thereto. For example, both an application run on a computer and a computer may correspond to a unit, module, device, or system of the present disclosure.

The method of the present disclosure is not limited to the order of the steps of each method, and some steps with other blocks may be performed in different order or simultaneously than those shown and described herein, and various other branches, flow paths, and sequences of steps may be implemented to achieve the same or similar results. Further, not all illustrated steps may be required for implementation of the method described herein. Furthermore, the method according to an embodiment of the present disclosure may be implemented in the form of a computer program for performing a series of processes, and the computer program may be recorded in a computer-readable recording medium.

Hereinafter, the configuration and characteristics of the present disclosure will be described using examples, but these examples are only illustrative of the present disclosure and are not limiting.

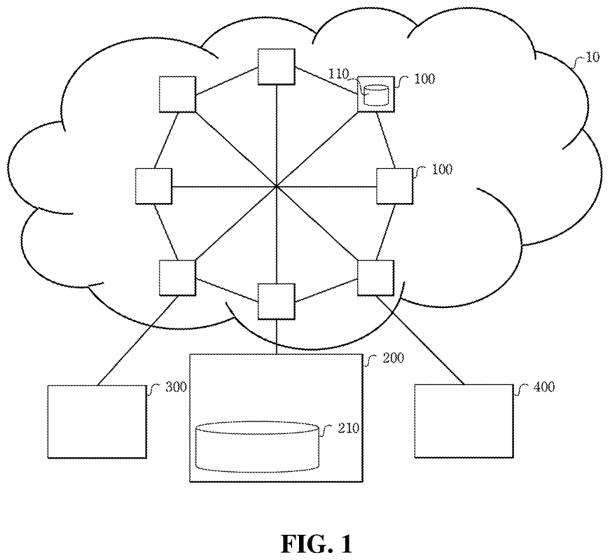

Hereinafter, a cryptocurrency trading brokerage server 200 in which a trading record of digital tokens is encrypted and which is connected to node servers 100 by a network having a block chain structure will be described with reference to FIG. 1. FIG. 1 illustrates the trading brokerage server 200 and components connected thereto, and what is not shown may be understood by the descriptions itself. In addition, the network shown in FIG. 1 is an example, and the range of the network is not limited to the range of the drawing.

In the present disclosure, a “block chain” may refer to a distributed computing storage in which data to be stored is stored in a distributed data storage environment in the form of a chain in which partial data in units of blocks are generated based on a peer to peer (P2P) method.

In the present disclosure, a “node” may refer to a configuration server of a network of a block chain structure in which partial data in block unit or all of the storage target data chain is stored.

In the present disclosure, “cryptocurrency” may refer to a digital currency in which issuance and trading records are distributed and stored in a network having a block chain structure.

The cryptocurrency connected to the network having the block chain structure according to the present disclosure may be a block chain-based cryptocurrency in a form that may implement the embodiments of the present disclosure or may be cryptocurrency modified to a form that may implement the embodiments of the present disclosure from an existing block chain platform.

The cryptocurrency trading brokerage server 200 according to the present disclosure is a server in which trading records of digital tokens are encrypted and which is connected to the node servers 100 by a network 10 having a block chain structure. The cryptocurrency trading brokerage server 200 may include a database 210 storing information required for a trading brokerage, a communication unit 220 capable of performing data communication with a node server or a wallet client.

The trading brokerage server 200 may store a trading rate value of an asset conversion value for a digital token in the database 210 of the trading brokerage server.

In the present disclosure, “digital token” may refer to a digital asset that may be traded on a block chain-structured network.

In the present disclosure, the “asset conversion value” may refer to a value stored after being obtained by converting the quantity of a real asset or a digital asset that may be traded with digital token into a digital value.

The real asset of the asset conversion value may be gold, dollar, won, or real estate, and the digital asset may be a cryptocurrency that is currently used, such as Bitcoin and Ethereum. Preferably, the asset conversion value may be the mass of gold or a currency exchange value of gold, which may increase payment security of the cryptocurrency according to the present disclosure.

The trading rate value may include a basic trading rate value and a current trading rate value.

In the present disclosure, the “trading rate value” may refer to a price of the quantity of the converted asset relative to the quantity of the unit digital token in a trading between a digital token and a converted asset.

In the present disclosure, the “basic trading rate value” may refer to a reference price at which market price fluctuation are controlled in a trading between a digital token and a converted asset.

In the present disclosure, the “current trading rate value” may refer to a current price in a trading between a digital token and a converted asset. The current trading rate value may be determined by a seller's asking price and a buyer's asking price and may be determined by a general method such as a method of determining a present price in a stock trading.

The trading brokerage server 200 may match a trading between a first wallet client 300 requesting the sale of digital tokens and a second wallet client 400 requesting the purchase of digital tokens within a predetermined fixed range of the basic rate value.

In the present disclosure, the “wallet client” stores an owner identification value of digital coins and asset conversion values traded on the block chain structure network and checks the type and quantity of assets owned in the block chain structure network. The wallet client is not limited in form as long as it can transfer money to other wallets and purchase and request digital coins. The wallet client may be a server capable of performing the functions described above, a terminal device capable of requesting it from a server through a communication unit, a storage device storing an owner identification value, or a node server storing all or some of block unit data chains.

The database 110 of the node server 100 may store trading records in units of at least one or more blocks.

The trading brokerage server 200 may not confirm a trading matching if a sale request price of the first wallet client 300 or a purchase request price of the second wallet client 400 is equal to or greater than a predetermined fixed rate with respect to the basic trading rate value. For example, the predetermined fixed rate may be 130% of the basic trading rate value. As a result, it is possible to control rapid market price volatility of the monetary system.

In the present disclosure, the “first wallet client” may refer to a wallet client that transmits a sale signal of owned digital coins together with a sale quantity and a sale price to the trading brokerage server 200.

In the present disclosure, the “second wallet client” may refer to a wallet client that transmits a purchase signal of digital coins together with a purchase quantity and a purchase price to the trading brokerage server 200.

The trading brokerage server 200 may update the current trading rate value stored in the database 210 of the trading brokerage server to a matched value at the time of matching. Accordingly, the trading brokerage server 200 may maintain the current market price information of the digital coins.

If the updated current trading rate value is equal to or greater than a predetermined fixed rate, the trading brokerage server 200 may request at least one of the node servers 100 to store a trading record of increasing a quantity value of digital tokens of a third wallet client by a predetermined value. For example, the predetermined fixed rate may be 130% of the basic trading rate value.

The trading brokerage server 200 may request at least one node server to store a trading record of increasing an asset conversion value of the third wallet client 500 at the same time of or after the storage request.

In this case, an increment of the asset conversion value may be a value corresponding to a part of an increment of the quantity value of the digital tokens. For example, the increment of the asset conversion value may be 90% of the increment of the quantity value of the digital tokens. Accordingly, liquidity may be provided to the monetary system, while a basis for payment is guaranteed because most of the value of the digital tokens is accumulated in the monetary system.

When the second wallet client 400 requests the purchase of digital tokens, a trading may be matched to a value lower by a predetermined value than the current trading rate value at the time of requesting storage of a trading record of increasing a quantity value of the digital tokens of the third wallet client 500. For example, the predetermined fixed rate may be 5% lower than the current trading rate value. As a result, it is possible to provide preferential factors for holding despite expansion of the monetary system, thereby inducing an increase in the value of the monetary system.

The quantity value of the digital tokens of the second wallet client 400 may exceed 0 when it is requested to store a trading record of increasing the quantity value of the digital tokens of the third wallet client 500 by a predetermined value. Accordingly, it is possible to provide preferential factors to existing digital token holders, thereby inducing an increase in the value of the monetary system and preventing a decrease in the value of the monetary system.

The trading brokerage server 200 may generate a wallet client according to a request from a certain client 600.

The generated wallet client 600 may be the first wallet client 300 or the second wallet client 400.

The first wallet client 300 may be controlled not to input a value greater than a predetermined fixed rate with respect to the basic trading rate value as a sale request price. For example, the predetermined fixed rate may be 130% of the basic trading rate value. As a result, rapid market price volatility of the monetary system may be controlled at the user's wallet level.

The second wallet client 400 may be controlled not to input a value greater than a predetermined fixed rate with respect to the basic trading rate value as a purchase request price.

For example, the predetermined fixed rate may be 130% of the basic trading rate value. As a result, rapid market price volatility of the monetary system may be controlled at the user's wallet level.

The trading brokerage server 200 may update the basic trading rate value to a current trading rate value at the time of the storage request. As a result, a market price fluctuation range may be controlled according to a size of an expanded monetary system by raising the standard for price fluctuation at the time new digital tokens are issued to the monetary system in which the price is increased.

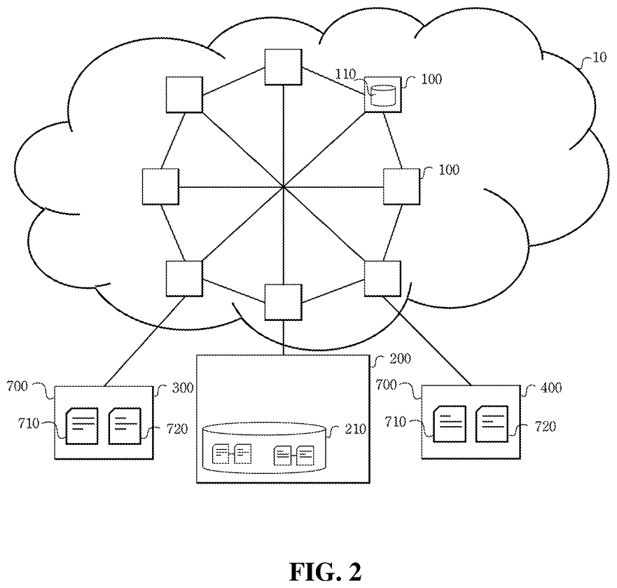

Hereinafter, a cryptocurrency trading brokerage server 200 in which a trading record of digital tokens is encrypted and which is connected to node servers by a network having a block chain structure according to another aspect of the present disclosure will be described with reference to FIG. 2. In the present disclosure, if there is no other description, the description of the cryptocurrency trading brokerage server 200 according to one aspect described above may be applied. In addition, FIG. 2 shows the trading brokerage server 200 and components connected thereto, and what is not shown may be understood by the description itself. In addition, the network shown FIG. 2 is an example and the range of the network is not limited to the range of the drawing.

The trading brokerage server 200 may request storing of an ownership authentication key value 720 matched to a private key 710 of a fourth wallet client 700 in the database of the trading brokerage server according to a request from the fourth wallet client 700. For example, the ownership authentication key value may be personal identification information such as an email address, a public certificate private key value, or a business registration number. In addition, the ownership authentication key value 720 may be biometric personal identification information such as a fingerprint recognition value and an iris recognition value. Accordingly, it is possible to prove an owner for a blind-owned wallet client whose identity is not exposed, thereby preventing loss of assets stored in the wallet even if the wallet client's private key is lost and enabling verification and restoration regarding remittance trading records against the intention of the owner due to hacking or the like.

The trading brokerage server 200 may match a trading between the first wallet client 300 requesting the sale of digital tokens and the second wallet client 400 requesting the purchase of digital tokens.

The first wallet client 300 and the second client 400 may be the fourth wallet client 700.

If a trading amount is equal to or greater than a predetermined value at the time of matching, the private key 710 and the ownership authentication key value 720 may be received from the fourth wallet client 700 and whether the private key 710 and the ownership authentication key value 720 are the same as matching information stored in the trading brokerage server may be verified. Accordingly, it is possible to prevent loss of assets stored in the wallet due to hacking by requesting owner verification for a trading of a certain amount or more regarding a blind-owned wallet client whose owner's identity is not exposed.

In an embodiment of the present disclosure, the trading brokerage server 200 matches remittance of a sixth wallet client 900 requesting the remittance of digital tokens by designating a certain fifth wallet client 800.

The sixth wallet client 900 may be the fourth wallet client 700.

If a remittance amount is equal to or greater than a predetermined value at the time of matching, the private key 710 and the ownership authentication key value 720 may be received from the sixth wallet client 900 and whether the private key 710 and the ownership authentication key value 720 are the same as matching information stored in the trading brokerage server may be verified. As a result, it is possible to prevent loss of assets stored in the wallet due to hacking by requesting owner verification for remittance of a certain amount or more regarding a blind-owned wallet client whose owner's identity is not exposed.

In an embodiment of the present disclosure, the trading brokerage server 200 may be requested to verify remittance of digital tokens designating the fifth wallet client 800 that has already been executed according to a request of the sixth wallet client 900.

If the remittance amount is more than a predetermined value and there is no verification details of the corresponding remittance trading in the database 210 of the trading brokerage server 200, the trading brokerage server 200 may receive the private key 710 and the ownership authentication key value 720 from the sixth wallet client 900, verify whether the private key 710 and the ownership authentication key value 720 are the same as the matching information stored in the trading brokerage server, and request transaction of a trading record corresponding to the remittance from at least one of the node servers 100. Accordingly, it is possible to verify and restore a remittance trading record against the intention of the owner due to hacking or the like regarding a blind-owned wallet client whose owner's identity is not exposed.

In this case, the ownership authentication key value 720 may be biometric personal identification information such as a fingerprint recognition value and an iris recognition value in consideration of a security level.

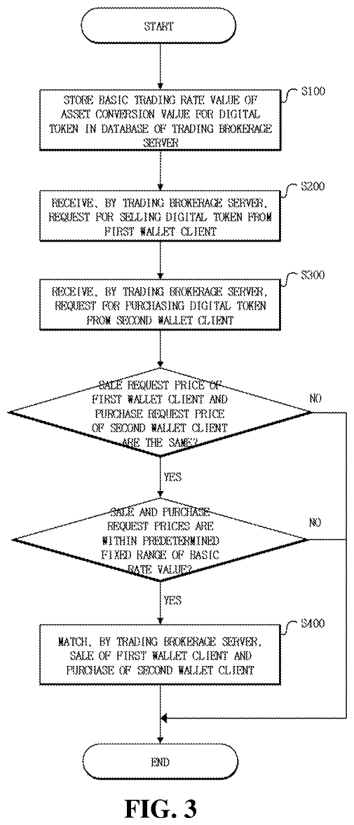

Hereinafter, a cryptocurrency trading method of the cryptocurrency trading brokerage server 200 in which a trading record of digital tokens is encrypted and which is connected to node servers by a network having a block chain structure according to another aspect of the present disclosure will be described with reference to FIG. 3. In the present disclosure, if there is no other description, the description of the cryptocurrency trading brokerage server 200 described above may be applied. FIG. 3 illustrates steps of the cryptocurrency trading brokerage method, and what is not shown may be understood by the description itself and is not limited to the order of the illustrated steps.

The cryptocurrency trading brokerage method may include storing a basic trading rate value of an asset conversion value for digital tokens in the database 210 of the trading brokerage server (S100);

receiving, by the trading brokerage server 200, a request to sell digital tokens from the first wallet client 300 (S200);

receiving, by the trading brokerage server 200, a request to purchase digital tokens from the second wallet client 400 (S300); and

matching, by the trading brokerage server 200, a trade if a sale request price of the first wallet client 300 and a purchase request price of the second wallet client 400 are the same and within a predetermined range of the basic rate value (S400).

In the matching (S400), trading is not matched if the sale request price of the first wallet client 300 or the purchase request price of the second wallet client 400 is equal to or greater than a predetermined fixed rate with respect to the basic trading rate value. For example, the predetermined fixed rate may be 130% of the basic trading rate value. As a result, it is possible to control rapid market price fluctuation of the monetary system.

The cryptocurrency trading brokerage method may further include updating the current trading rate value stored in the database of the trading brokerage server at the time of matching (S400) to a matched value (S410). Accordingly, the trading brokerage server 200 may maintain the current market price information of the digital coins.

The cryptocurrency trading brokerage method may further include requesting at least one of the node servers 100 to store a trading record of increasing a quantity value of digital tokens of the third wallet client 500 if the updated current trading rate value is equal to or greater than predetermined fixed rate (S500). For example, the predetermined fixed rate may be 130% of the basic trading rate value.

The cryptocurrency trading brokerage method may further include requesting, by the trading brokerage server 200, at least one of the node servers 100 to store a trading record of increasing an asset conversion value of the third wallet client 500 (S510). Accordingly, an increment of the asset conversion value may be a value corresponding to a part of an increment of the quantity value of the digital tokens. For example, the increment of the asset conversion value may be 90% of the increment of the quantity value of the digital tokens. Accordingly, liquidity may be provided to the monetary system, while a basis for payment is guaranteed because most of the value of the digital tokens is accumulated in the monetary system.

In this case (S510), the increment of the asset conversion value in the step (S510) of requesting storage of the trading record of increasing the asset conversion value of the third wallet client 500 may be a value corresponding to a part of the increment of the quantity value of the digital tokens. For example, the predetermined fixed rate may be 5% lower than the current trading rate value. As a result, it is possible to provide preferential factors for holding despite expansion of the monetary system, thereby inducing an increase in the value of the monetary system.

The cryptocurrency trading brokerage method may further include matching a trading to a value lower by a predetermined rate than the current trading rate value at the time of requesting storage of the trading record of increasing the quantity value of the digital tokens of the third wallet client 500 by a predetermined value when the second wallet client 400 requests purchase of digital tokens (S511).

In this case (S511), the quantity value of the digital tokens of the second wallet client 400 may exceed 0 when it is requested (S500) to store a trading record of increasing the quantity value of the digital tokens of the third wallet client 500 by a predetermined value. Accordingly, it is possible to provide preferential factors to existing digital token holders, thereby inducing an increase in the value of the monetary system and preventing a decrease in the value of the monetary system.

The cryptocurrency trading brokerage method may further include generating, by the trading brokerage server 200, a wallet client 600 according to a request of the certain client 600 (S600).

In this case (S600), the generated wallet client 600 may be the first wallet client 300 or the second wallet client 400, and the first wallet client 300 may be controlled not to input a value greater than a predetermined fixed rate with respect to the basic trading rate value as a sale request price, and the second wallet client 400 may be controlled not to input a value greater than a predetermined fixed rate with respect to the basic trading rate value as a purchase request price. For example, the predetermined fixed rate may be 130% of the basic trading rate value. As a result, rapid market price volatility of the monetary system may be controlled at the user's wallet level.

The cryptocurrency trading brokerage method may further include updating, by the trading brokerage server 200, the basic trading rate value to a current trading rate value at the time of the storage request (S700). As a result, a market price fluctuation range may be controlled according to a size of an expanded monetary system by raising the standard for price fluctuation at the time new digital tokens are issued to the monetary system in which the price is increased.

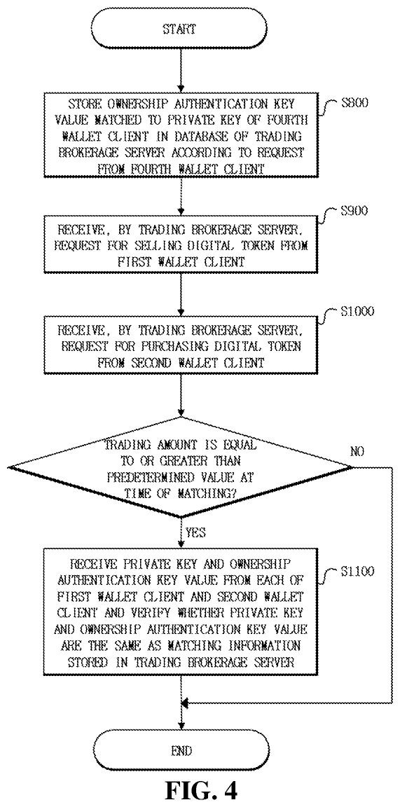

Hereinafter, a cryptocurrency trading brokerage method of the cryptocurrency trading brokerage server 200 in which a trading record of digital tokens is encrypted and which is connected to node servers by a network having a block chain structure according to another aspect of the present disclosure will be described with reference to FIG. 4. In the present disclosure, if there is no other description, the description of the cryptocurrency trading brokerage server 200 described above and the cryptocurrency trading brokerage method of the cryptocurrency trading brokerage server 200 described above may be applied. In addition, FIG. 4 illustrates the cryptocurrency trading brokerage method and steps thereof, and what is not shown may be understood by the description itself and is not limited to the order of the illustrated steps.

The cryptocurrency trading brokerage method may further include storing, by the trading brokerage server 200, an ownership authentication key value matched to the private key 710 of the fourth wallet client 700 in the database 210 of the trading brokerage server 200 according to a request from the fourth wallet client 700 (S800). For example, the ownership authentication key value may be personal identification information such as an email address, a public certificate private key value, and a business registration number. Accordingly, it is possible to prove an owner for a blind-owned wallet client whose owner's identity is not exposed, thereby preventing loss of assets stored in the wallet even if a private key of a wallet client is lost.

The cryptocurrency trading brokerage method further includes receiving, by the trading brokerage server 200, a request to sell digital tokens from the first wallet client 300 (S900);

receiving, by the trading brokerage server, a request to purchase a digital token from the second wallet client 400 (S1000); and

receiving the private key 710 and the ownership authentication key value 720 from each of the first wallet client 300 corresponding to the fourth wallet client 700 and the second wallet client 400 corresponding to the fourth wallet client 700 and verifying whether the private key 710 and the ownership authentication key value 720 are the same as the matching information stored in the trading brokerage server, if a trading amount is equal to or greater than a predetermined value at the time of matching (S1100). When the trading amount is greater than or equal to the predetermined value at the time of matching, the private key 710 and the ownership authentication key value 720 may be received from the fourth wallet client 700 to verify whether the private key 710 and the ownership authentication key value 720 are the same as the matching information stored in the trading brokerage server. Accordingly, by requesting owner verification for a trading of a certain amount or more regarding a blind-owned wallet client whose owner's identity is not exposed, it is possible to prevent loss of assets stored in the wallet due to hacking or the like and enable verification and restoration of a remittance trading record against the intention of the owner due to hacking or the like.

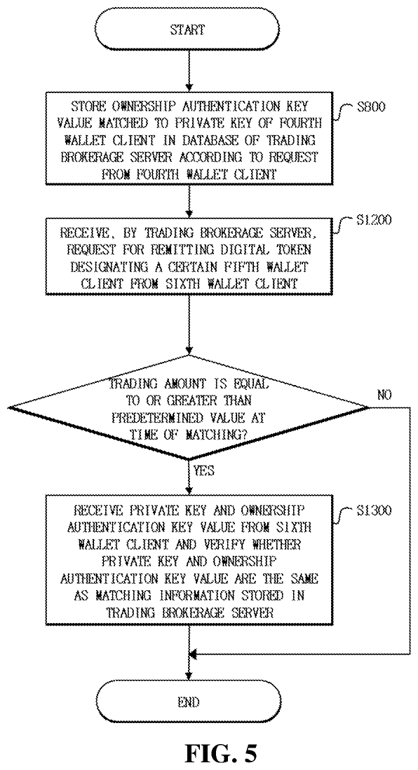

Referring to FIG. 5, in an embodiment of the present disclosure, the cryptocurrency trading brokerage method may further include receiving a request for remittance of digital tokens designating a certain fifth wallet client from a sixth wallet client (S1200); and

receiving the private key 700 and the ownership authentication key value 710 from the sixth wallet client corresponding to the fourth wallet client and verifying whether the private key 700 and the ownership authentication key value 710 are the same as the matching information stored in the trading brokerage server (S1300). Accordingly, it is possible to prevent loss of assets stored in the wallet due to hacking by requesting owner verification for remittance of a certain amount or more regarding a blind-owned wallet client whose owner's identity is not exposed.

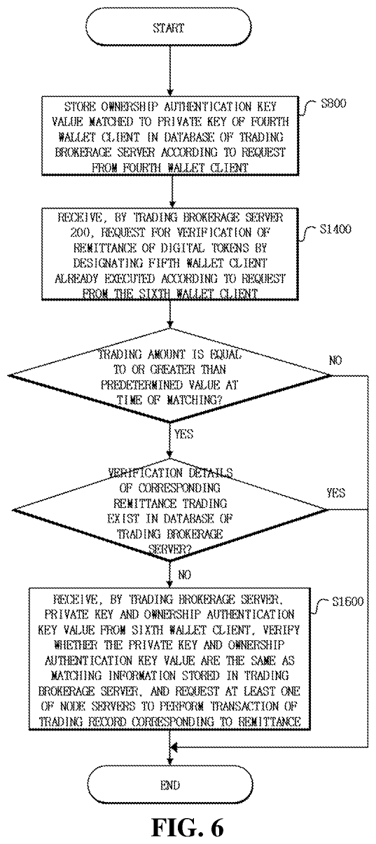

Referring to FIG. 6, in an embodiment of the present disclosure, the cryptocurrency trading brokerage method may include receiving, by the trading brokerage server 200, a request for verification of remittance of digital tokens designating the certain fifth wallet client 800 already executed according to a request from the sixth wallet client 900 (S1400); and

receiving, by the trading brokerage server 200, the private key 700 and the ownership authentication key value 710 from the sixth wallet client, verifying whether the private key 700 and the ownership authentication key value 710 are the same as the matching information stored in the trading brokerage server, and requesting at least one of the node servers 100 to perform transaction of a trading record corresponding to the remittance, if the remittance amount is equal to or greater than a predetermined value and there is no verification details of the corresponding remittance trading in the database 210 of the trading brokerage server 200 (S1500). Accordingly, it is possible to verify and restore a remittance trading record against the intention of the owner due to hacking or the like regarding a blind-owned wallet client whose owner's identity is not exposed.

In this case, the ownership authentication key value 720 may be biometric personal identification information such as a fingerprint recognition value and an iris recognition value in consideration of a security level.

The present disclosure may also provide a program for performing each step of the cryptocurrency trading brokerage method described above.

The present disclosure may also provide a computer-readable recording medium storing the program described above.

Although the present disclosure has been described in terms of specific items such as detailed elements as well as the limited embodiments and the drawings, they are only provided to help more general understanding of the invention, and the present disclosure is not limited to the above embodiments. It will be appreciated by those skilled in the art to which the present disclosure pertains that various modifications and changes may be made from the above description.

Therefore, the spirit of the present disclosure shall not be limited to the above-described embodiments, and the entire scope of the appended claims and their equivalents will fall within the scope and spirit of the invention.

### DESCRIPTION OF REFERENCE NUMERALS

10: network

100: node server

110: database

200: trading brokerage server

210: database

700: fourth wallet client

710: private key

720: ownership authentication key value

### INDUSTRIAL AVAILABILITY

The present disclosure relates to a block chain-based cryptocurrency trading brokerage server and trading brokerage method capable of controlling price fluctuation and preventing change of ownership due to hacking, whereby a value of digital tokens is secured as actual assets, i.e., assets such as gold, in a monetary system, supporting stability, a rapid market price fluctuation are controlled by limiting a range of a market price of digital tokens, the demand for price rise due to lack of currency in the monetary system is absorbed by issuing digital tokens in case of limited market price rise, and, at the time of issuance, digital tokens are provided to existing digital token holders at a lower price than the issuance price, providing incentives to reward early participants, and may be utilized in fields such as e-commerce between companies.

What is claimed is:

1. A cryptocurrency trading brokerage server in which a trading record of digital tokens is encrypted and which is connected to node servers by a network having a block chain structure,
wherein the trading brokerage server stores a trading rate value of assets conversion value for the digital tokens in a database of the trading brokerage server,
the trading rate value includes a basic trading rate value and a current trading rate value, and
the trading brokerage server matches a trading between a first wallet client requesting sale of digital tokens and a second wallet client requesting purchase of digital tokens within a predetermined fixed range of the basic rate value.

2. The cryptocurrency trading brokerage server of claim 1, wherein
databases of the node servers store trading records in at least one block unit.

3. The cryptocurrency trading brokerage server of claim 1, wherein
the trading brokerage server does not confirm trading matching if a sale request price of the first wallet client or a purchase request price of the second wallet client is equal to or greater than a predetermined fixed rate with respect to the basic trading rate value.

4. The cryptocurrency trading brokerage server of claim 1, wherein
the trading brokerage server updates the current trading rate value stored in the database of the trading brokerage server to a matched value at the time of matching.

5. The cryptocurrency trading brokerage server of claim 1, wherein
the trading brokerage server requests at least one of the node servers to store a trading record of increasing the quantity of digital tokens of a third wallet client by a predetermined value, if the updated current trading rate value is equal to or greater than a predetermined fixed rate.

6. The cryptocurrency trading brokerage server of claim 5, wherein
the trading brokerage server requests at least one of the node servers to store a trading record of increasing an asset conversion value of the third wallet client simultaneously when requesting the storage or later.

7. The cryptocurrency trading brokerage server of claim 6, wherein
an increment of the asset conversion value is a value corresponding to a portion of an increment of the quantity of the digital tokens.

8. The cryptocurrency trading brokerage server of claim 6, wherein
the trading brokerage server matches a trading to a value lower by a predetermined rate than the current trading rate value at the time of requesting storage of the trading record of increasing the quantity of the digital tokens of the third wallet client by a predetermined value, when the second wallet client requests purchase of digital tokens.

9. The cryptocurrency trading brokerage server of claim 8, wherein
the quantity of the digital tokens of the second wallet client exceeds 0, at the time of requesting storage of the trading record of increasing the quantity of the digital tokens of the third wallet client by a predetermined value.

10. The cryptocurrency trading brokerage server of claim 1, wherein
the trading brokerage server creates a wallet client according to a request from a certain client.

11. The cryptocurrency trading brokerage server of claim 10, wherein
the created wallet client is the first wallet client or the second wallet client, the first wallet client does not input a value equal to or greater than a predetermined fixed rate with respect to the basic trading rate value as a sale request price, and the second wallet client does not input a value equal to or greater than a predetermined fixed rate with respect to the basic trading rate value as a purchase request price.

12. The cryptocurrency trading brokerage server of claim 5, wherein
the trading brokerage server updates the basic trading rate value to the current trading rate value at the time of requesting storage.

13. A cryptocurrency trading brokerage server in which a trading record of digital tokens is encrypted and which is connected to node servers by a network having a block chain structure,
wherein the trading brokerage server stores an ownership authentication key value matched to a private key of a fourth wallet client upon receiving a request from the fourth wallet client in a database of the trading brokerage server.

14. The cryptocurrency trading brokerage server of claim 13, wherein
the trading brokerage server matches a trading between a first wallet client requesting sale of digital tokens and a second wallet client requesting purchase of digital tokens,
the first wallet client and the second wallet client are the fourth wallet client, and
the trading brokerage server receives a private key and an ownership authentication key from the fourth wallet client and verifies whether the private key and the ownership authentication key are the same as the matching information stored in the trading brokerage server, if a trading amount is equal to or greater than a predetermined value at the time of matching.

15. The cryptocurrency trading brokerage server of claim 13, wherein
the trading brokerage server matches a remittance of a sixth wallet client requesting the remittance of digital tokens by designating a certain fifth wallet client,
the sixth wallet client is the fourth wallet client, and
the trading brokerage server receives a private key and an ownership authentication key value from the sixth wallet client and verifies whether the private key and the ownership authentication key value are the same as matching information stored in the trading brokerage server, if the amount of remittance is equal to or greater than a predetermined value at the time of matching.

16. The cryptocurrency trading brokerage server of claim 13, wherein
the trading brokerage server matches a remittance of a sixth wallet client requesting the remittance of digital tokens by designating a certain fifth wallet client,
the sixth wallet client is the fourth wallet client, and
the trading brokerage server receives a private key and an ownership authentication key value from the sixth wallet client, verifies whether the private key and the ownership authentication key value are the same as matching information stored in the trading brokerage server, and requests a transaction of a trading record corresponding to the remittance from at least one of the node servers, if the amount of remittance is equal to or greater than a predetermined value and there is no verification details of the corresponding remittance trading in the database of the trading brokerage server.

17. A cryptocurrency trading brokerage method of a cryptocurrency trading brokerage server in which a trading record of digital tokens is encrypted and which is connected to node servers by a network having a block chain structure, the cryptocurrency trading brokerage method comprising:
storing a basic trading rate value of an asset conversion value for a digital token in a database of the trading brokerage server;
receiving, by the trading brokerage server, a request for sale of digital tokens from a first wallet client;
receiving, by the trading brokerage server, a request for purchase of digital tokens from a second wallet client; and
matching, by the trading brokerage server, a trading if a sale request price of the first wallet client and a purchase request price of the second wallet client are equal and are within a predetermined range of a basic rate value.

18. The cryptocurrency trading brokerage method of claim 17, wherein
in the matching, trading matching is not performed if the sale request price of the first wallet client or the purchase request price of the second wallet client is equal to or greater than a predetermined fixed rate with respect to the basic trading rate value.

19. The cryptocurrency trading brokerage method of claim 17, further comprising:
updating the current trading rate value stored in the database of the trading brokerage server to a matched value at the time of matching.

20. The cryptocurrency trading brokerage method of claim 17, further comprising:
requesting, by the trading brokerage server, at least one of the node servers to store a trading record of increasing the quantity of digital tokens of a third wallet client by a predetermined value, if the updated current trading rate value is equal to or greater than a predetermined fixed rate.

21. The cryptocurrency trading brokerage method of claim 20, further comprising:
requesting, by the trading brokerage server, at least one of the node servers to store a trading record of increasing an asset conversion value of a third wallet client.

22. The cryptocurrency trading brokerage method of claim 21, wherein
in the requesting of storage of the trading record of increasing the asset conversion value of the third wallet client, an increment of the asset conversion value is a value corresponding to a portion of an increment of the quantity of the digital tokens.

23. The cryptocurrency trading brokerage method of claim 21, further comprising:
matching a trading to a value lower by a predetermined rate than the current trading rate value at the time of requesting storage of the trading record of increasing the quantity of the digital tokens of the third wallet client by a predetermined value, when the second wallet client requests purchase of digital tokens.

24. The cryptocurrency trading brokerage method of claim 23, wherein
the quantity of the digital tokens of the second wallet client exceeds 0, at the time of requesting storage of the trading record of increasing the quantity of the digital tokens of the third wallet client by a predetermined value.

25. The cryptocurrency trading brokerage method of claim 17, further comprising:
creating, by the trading brokerage server, a wallet client according to a request from a certain client.

26. The cryptocurrency trading brokerage method of claim 25, wherein
the created wallet client is the first wallet client or the second wallet client, the first wallet client does not input a value equal to or greater than a predetermined fixed rate with respect to the basic trading rate value as a sale request price, and the second wallet client does not input a value equal to or greater than a predetermined fixed rate with respect to the basic trading rate value as a purchase request price.

27. The cryptocurrency trading brokerage method of claim 20, further comprising:
updating, by the trading brokerage server, the basic trading rate value to the current trading rate value at the time of requesting storage.

28. A cryptocurrency trading brokerage method of a cryptocurrency trading brokerage server in which a trading record of digital tokens is encrypted and which is connected to node servers by a network having a block chain structure, the cryptocurrency trading brokerage method comprising:
storing an ownership authentication key value matched to a private key of a fourth wallet client upon receiving a request from the fourth wallet client in a database of the trading brokerage server.

29. The cryptocurrency trading brokerage method of claim 28, further comprising:
receiving, by the trading brokerage server, a request of sale of digital tokens from a first wallet client;
receiving, by the trading brokerage server, a request of purchase of digital tokens from a second wallet client; and
receiving a private key and an ownership authentication key from each of the first wallet client corresponding to the fourth wallet client and the second wallet client corresponding to the fourth wallet client and verifying whether the private key and the ownership authentication key are the same as the matching information stored in the trading brokerage server, if a trading amount is equal to or greater than a predetermined value at the time of matching.

30. The cryptocurrency trading brokerage method of claim 28, further comprising:
receiving, by the trading brokerage server, a request of remitting digital tokens designating a certain fifth wallet client from a sixth wallet client; and
receiving a private key and an ownership authentication key value from the sixth wallet client corresponding to the fourth wallet client and verifying whether the private key and the ownership authentication key value are the same as matching information stored in the trading brokerage server, if the amount of remittance is equal to or greater than a predetermined value at the time of matching.

31. The cryptocurrency trading brokerage method of claim 28, further comprising:
receiving, by the trading brokerage server, a request for verifying remittance of digital tokens designating a certain fifth wallet client already executed according to a request from a sixth wallet client; and
receiving a private key and an ownership authentication key value from the sixth wallet client, verifying whether the private key and the ownership authentication key value are the same as matching information stored in the trading brokerage server, and requesting a transaction of a trading record corresponding to the remittance from at least one of the node servers, if the amount of remittance is equal to or greater than a predetermined value and there is no verification details of the corresponding remittance trading in the database of the trading brokerage server.
